(19) United States
(12) Patent Application Publication
(10) Pub. No.: US 2025/0328378 A1
(43) Pub. Date: Oct. 23, 2025

(54) SYSTEMS AND METHODS FOR SCHEDULING AND PROVIDING OPTIMAL DOMAIN RESOURCES TO CONSUMERS

(71) Applicant: Verizon Patent and Licensing Inc., Basking Ridge, NJ (US)

(72) Inventor: Mehmet TOY, Allendale, NJ (US)

(73) Assignee: Verizon Patent and Licensing Inc., Basking Ridge, NJ (US)

(21) Appl. No.: 18/643,218

(22) Filed: Apr. 23, 2024

(51) Int. Cl. G06F 9/48; G06F 9/445

(52) U.S. Cl. CPC G06F 9/4881; G06F 9/44578

(57) ABSTRACT

A device may receive a resource request for a domain with resource types, and may assign a classification to the resource request. The device may identify a queue position for the resource request, and may determine resource parameters for the resource request based on resource characteristics. The device may process the resource parameters and optimized parameter values, with a resource optimizer model, to generate optimized resource parameters. The device may process the resource types of the domain, with one or more resource scheduling models and based on the optimized resource parameters, to generate a consumption schedule for the resource types, and may service the resource request based on the consumption schedule for the resource types.

### BACKGROUND

With the proliferation of virtualization and cloud services by cloud service providers, computing, memory, and storage resources that are located mostly in data centers and/or embedded into network devices are used for networking, applications, and management of services offered in a domain that includes such resources, networking, and applications. The concept of sharing resources among networking, applications, and management of a service (e.g., a connectivity service or a cloud service) may be referred to as convergence of networking, applications, and management.

### BRIEF DESCRIPTION OF THE DRAWINGS

FIGS. 1A-1L are diagrams of an example associated with scheduling and providing optimal resources of a domain to consumers of the domain.

FIG. 2 is a diagram of an example environment in which systems and/or methods described herein may be implemented.

FIG. 3 is a diagram of example components of one or more devices of FIG. 2.

FIG. 4 is a flowchart of an example process for scheduling and providing optimal resources of a domain to consumers of the domain.

### DETAILED DESCRIPTION OF EXAMPLE EMBODIMENTS

The following detailed description of example implementations refers to the accompanying drawings. The same reference numbers in different drawings may identify the same or similar elements.

Computing and networking convergence arises from the need to support a wide array of cloud services (e.g., provided by cloud service providers) that utilize processing power (e.g., central processing unit (CPU) power), memory, and storage for both networking functions and computing tasks. Current techniques for managing resources of a domain fail to accurately capture interactions between the resources supporting connectivity and cloud services, and fail to efficiently utilize critical domain resources, such as compute, memory, and storage. Management challenges are further compounded by resource sharing among different domains within a service provider's network or even across multiple service providers. Such resource sharing necessitates sophisticated management and queuing techniques that can handle varying consumer demands for services that are eventually mapped to computing, memory, and storage resources. These complexities are not addressed by current techniques for managing domain resources, which often result in suboptimal resource usage and can lead to decreased performance of the network, increased operational costs, and ineffective management of domain resources. Moreover, the current techniques for managing domain resources do not consider various resource parameters, such as geographical distribution of consumer locations in relation to domain resource locations (e.g., data centers), which can significantly impact the performance of cloud services.

Some implementations described herein provide a domain system, or a separate entity dealing with resource optimization within a domain and across domains, that schedules and provides optimal resources of a domain to consumers of the domain resources. For example, the domain system may receive a resource request for a domain with resource types, and may assign a classification to the resource request or the resource request may include a classification embedded in a header of the resource request. The domain system may process the resource parameters and parameter values, with a resource optimizer model, to generate optimized resource parameters. The domain system may process the resource types of the domain, with one or more resource scheduling models and based on the optimized resource parameters, to generate a consumption schedule for the resource types, and may service the resource request based on the consumption schedule for the resource types. In some implementations, the domain system may be associated with many devices requesting services. The domain system may receive many resource requests based on the requested services, and may schedule these resource requests according to their classifications, as described elsewhere herein.

In some implementations, the optimized resource parameters and the consumption schedule generated by the domain system may be valid for a given time period (e.g., a time slot or a time interval). In another time slot or time interval, resources can be re-prioritized based on their parameter values, and new optimized resource parameters and a new consumption schedule may be generated. In some implementations, resource optimization may be performed by the domain system or by an independent resource optimization system separate from the domain system. In some implementations, resource optimization and scheduling may be performed by the domain system, but request classification (e.g., as high importance, medium importance, or low importance) may be performed via a message header or a message from the domain system. In some implementations, a request priority may be communicated via a message header using, for example, differentiated services code point (DSCP) coding of Internet protocol (IP) packets or priority code point (PCP) coding of Ethernet frames.

In this way, the domain system schedules and provides optimal resources of a domain to consumers of the domain. For example, the domain system may determine resource parameters for scheduling resources based on a model that selects resources according to a set of parameters, such as size, bandwidth, utilization, distance, processor speed, memory/storage speed, and/or the like. The domain system may select resources to meet specific consumer requirements and priorities for resource allocation. The domain system may schedule the selected resources for use by assigning the selected resources in an order based on the optimization of the resource parameters, and may allocate the selected resources to fulfill consumer requests within the domain (e.g., a market segment with services offered by a service provider and managed by a domain system). The domain system may dynamically adjust the allocation of the selected resources based on changes in the resource parameters, which may ensure efficient and responsive resource management for the domain. Thus, the domain system may conserve computing resources, networking resources, and/or other resources that would have otherwise been consumed by handling poor consumer experiences associated with accessing domain resources, inefficiently utilizing domain resources, decreasing performance of domain resources, handling lost traffic associated with accessing domain resources, and/or the like.

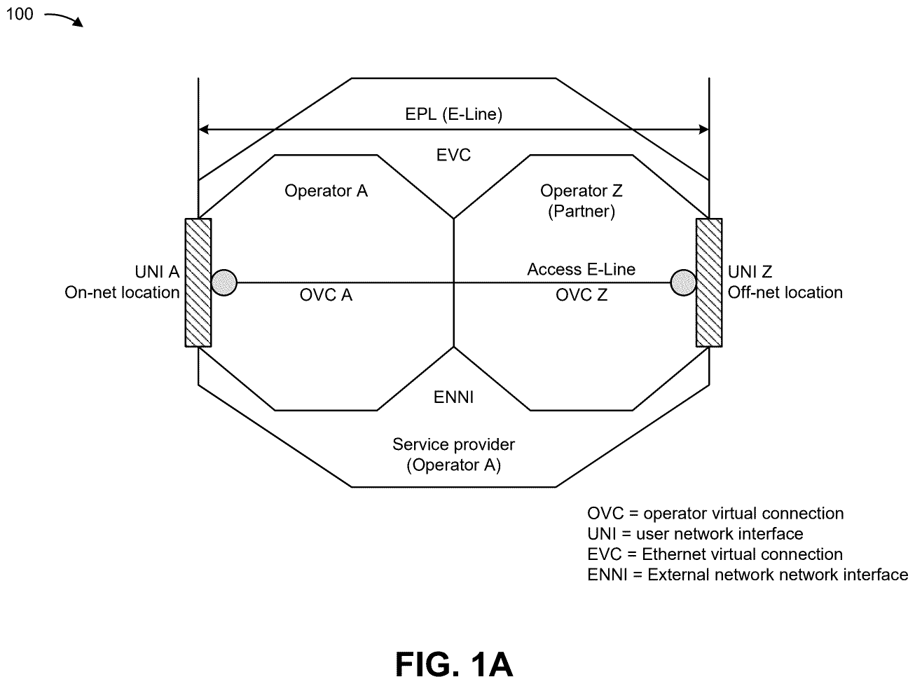

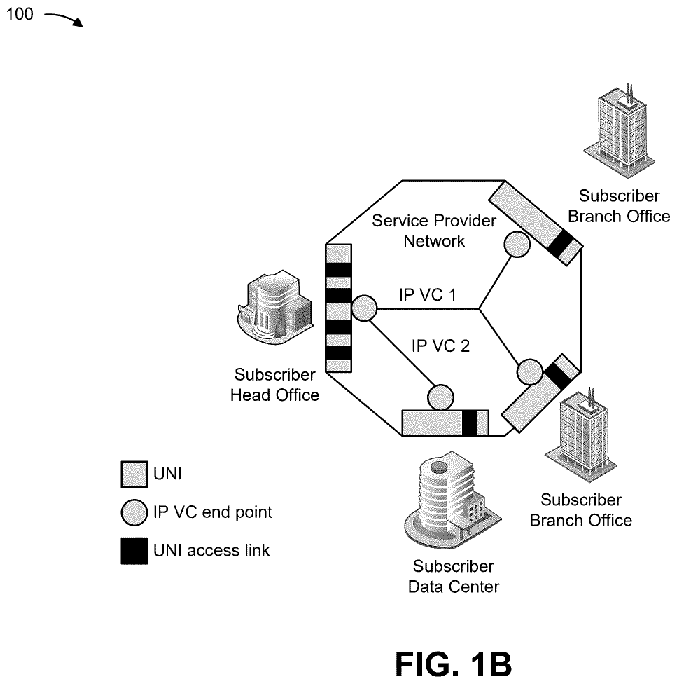

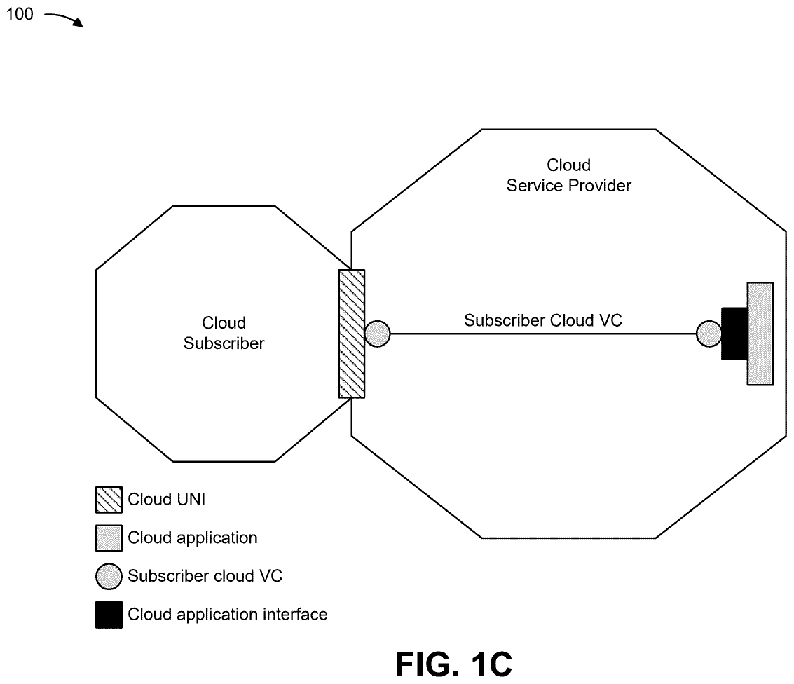

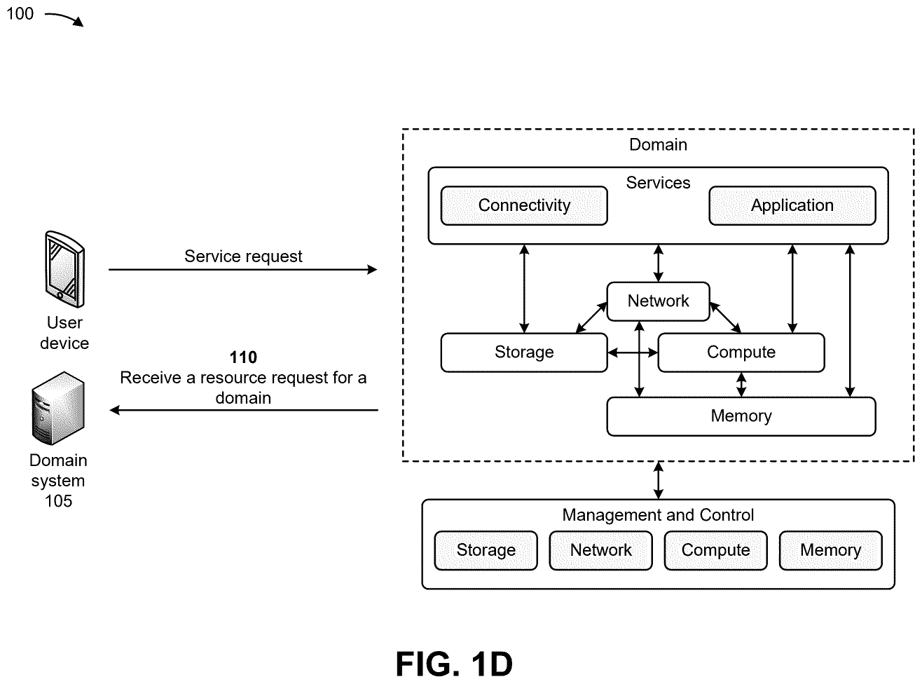

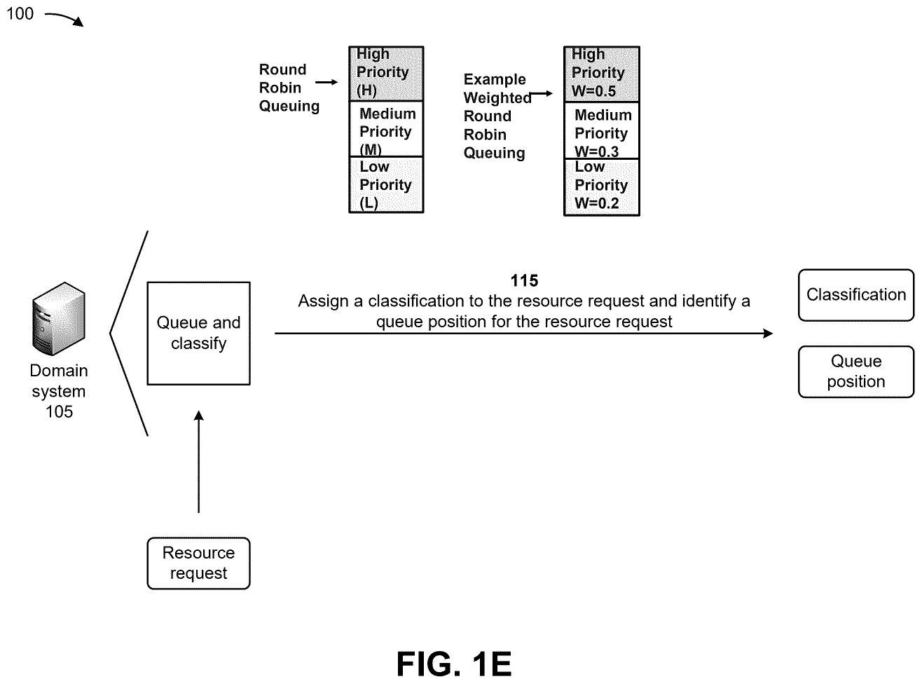

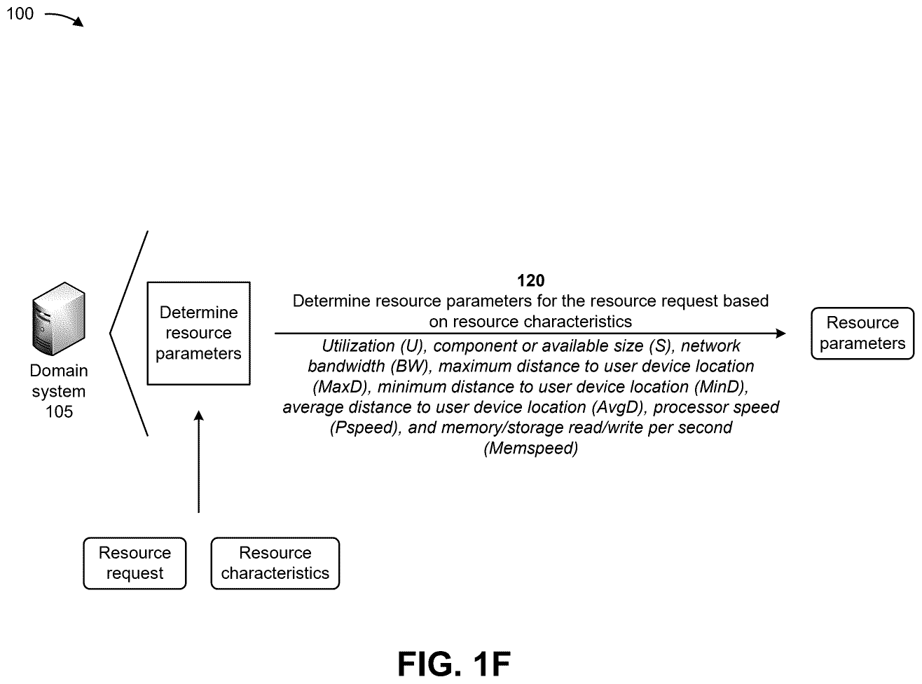

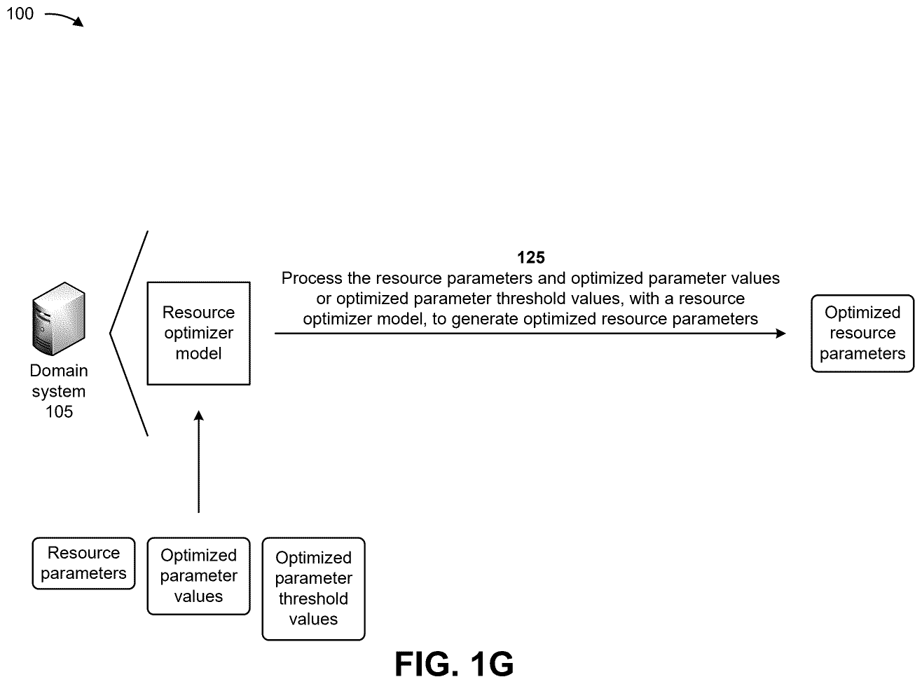

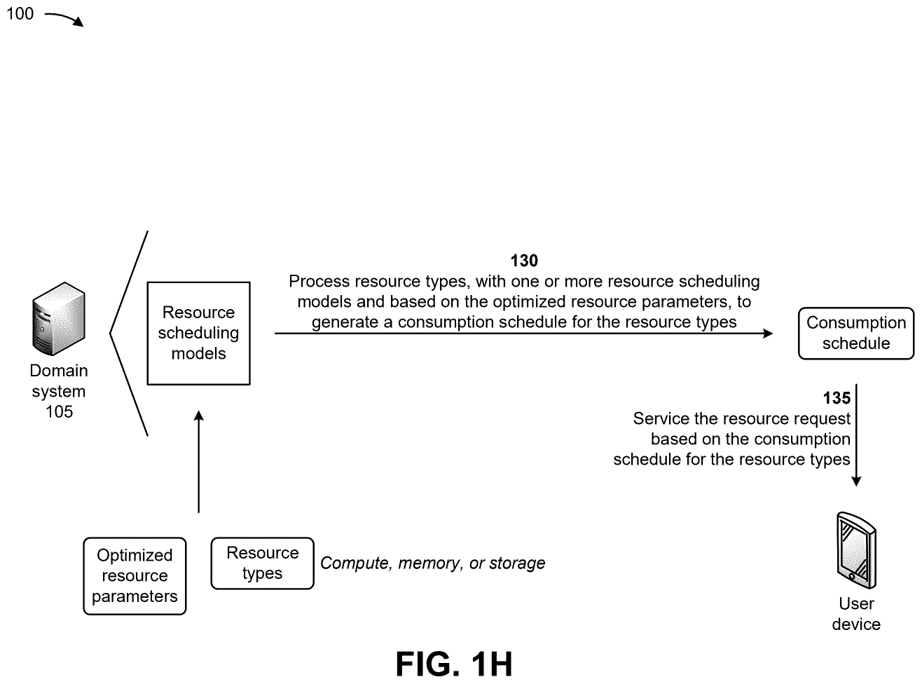

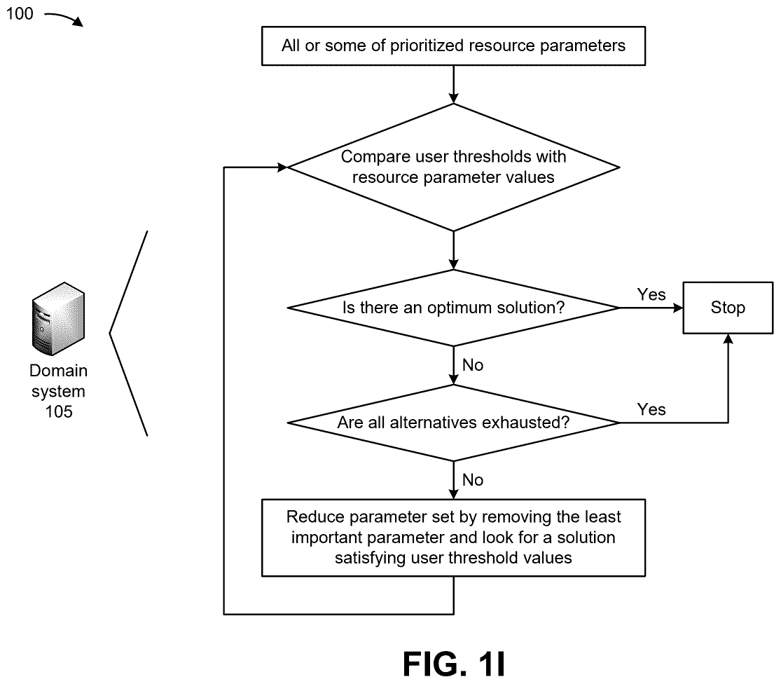

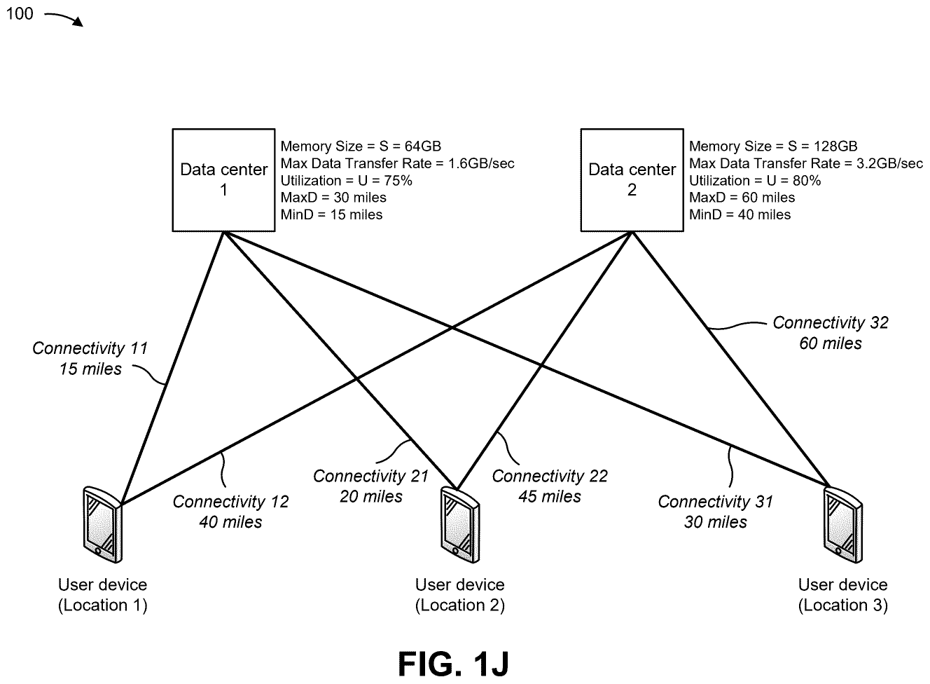

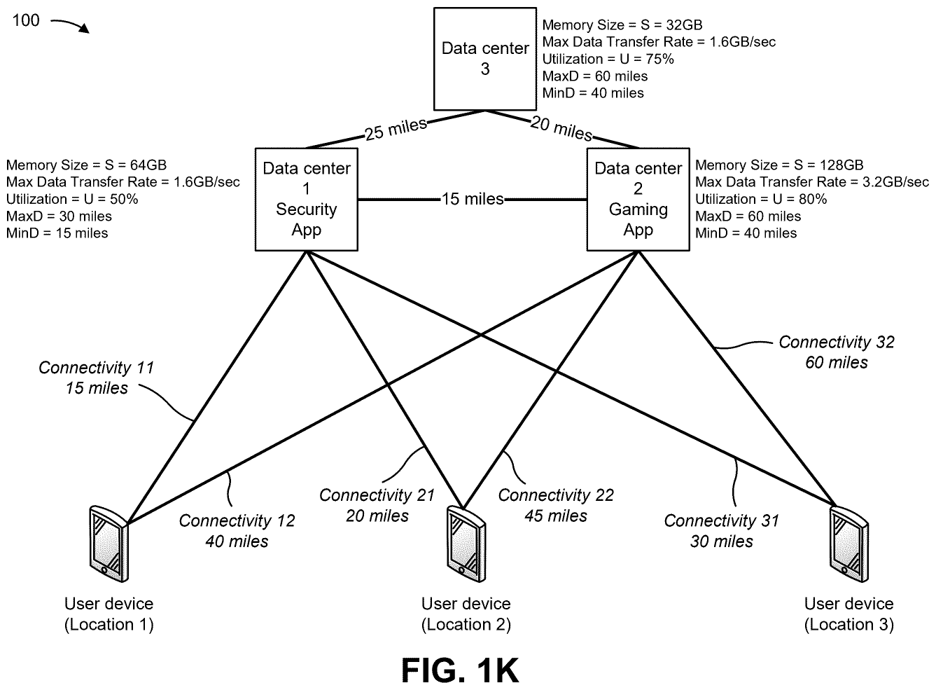

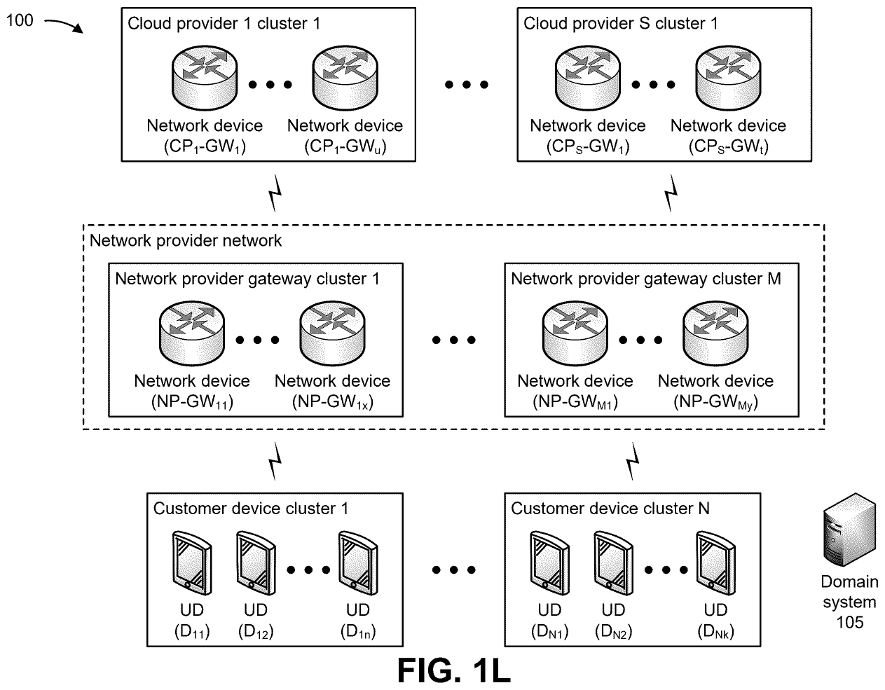

FIGS. 1A-1L are diagrams of an example 100 associated with scheduling and providing optimal resources of a domain to consumers of the domain. FIGS. 1A-1C depict examples of an Ethernet connectivity service, an IP connectivity service, and a cloud service model. As shown in FIG. 1A, an Ethernet private line (e.g., an E-Line) may provide a point-to-point Ethernet connectivity service between a location of a first operator (e.g., Operator A) and a location of a second operator (e.g., Operator Z). The Ethernet connectivity service may be offered by Operator A as a service provider and may be jointly supported by Operator A and Operator Z. From a resource sharing perspective, Operator A is a first domain (e.g., Domain A) and Operator Z is a second domain (e.g., Domain Z). In each domain, management and networking components may have resources, such as computing, memory, and storage.

As shown in FIG. 1B, a multipoint IP connectivity service (e.g., IP virtual connection 1 (VC1)) may be provided between a subscriber head office and subscriber branch offices. A point-to-point IP connectivity service (e.g., IP VC2) may be provided between the subscriber head office and a subscriber data centers. As shown in FIG. 1C, a cloud service model may include a cloud subscriber and a cloud service provider. The cloud subscriber may communicate with a cloud application (e.g., provided by the cloud service provider) via a cloud user network interface (UNI), a subscriber cloud VC, and a cloud application interface.

As shown in FIGS. 1D-1L, the example 100 includes a domain system 105 associated with one or more user devices and a domain (e.g., one or more cloud computing environments, one or more data centers, and/or the like). Further details of the domain system 105, the user device, and the domain are provided elsewhere herein. Although the domain system 105 is depicted as performing several functions, in some implementations, one or more of the functions described as being performed by the domain system 105 may be performed by another system. For example, a resource request priority may be communicated based on embedding the resource request priority in a message header, scheduling functions described herein may be performed by a system independent of the domain system 105, queuing requests of a resource may be available at the resource, and/or the like.

As shown in FIG. 1D, the domain may include components, such as connectivity services over network, applications that can form cloud services together with connectivity; and a storage component, a compute component, a memory component, and/or the like that correspond to resource types of the domain. In some implementations, resource sharing may occur among the resources (e.g., a cluster of processors) within the domain, and the domain may include a region with multiple distributed data centers or multiple regions of a service provider or a cloud service provider.

The connectivity services may include one or more resources of the domain that provide, to a consumer (e.g., the user device), domain connectivity services, such as providing connectivity between the domain, the Internet, and enterprise private networks. A domain connectivity service may provide a secure, low-latency, infinitely scalable connectivity between every user, application, infrastructure, management, and control. The cloud services may include one or more resources of the domain that provide applications and connectivity to a consumer (e.g., the user device). The network component may include one or more resources (e.g., network devices) of the domain that provide a network for other resources of the domain, such as management and control, storage, compute, and memory resources of the domain. The storage component may include one or more resources (e.g., data structures, storage devices, and/or the like) of the domain that provide storage for a domain consumer (e.g., application, connectivity, management, and control). The compute component may include one or more resources (e.g., processors, servers, and/or the like) of the domain that provide computation services for a domain consumer (e.g., application, connectivity, management, and control). The memory component may include one or more resources (e.g., data structures, memory devices, and/or the like) of the domain that provide memory services for a domain consumer (e.g., application, connectivity, management, and control).

The domain may be associated with a management and control system that manages and controls the domain service components (e.g., the connectivity and application) and domain resources (e.g., the network component, the storage component, the compute component, the memory component, and/or the like). The management and control system may also include resources, such as a storage component, a network component, a compute component, a memory component, and/or the like. The domain may include domain consumers (e.g., the connectivity, the application, and the management and control system) and domain resources (e.g., the network component, the storage component, the compute component, and the memory component). The management and control system may correspond to an operations support system (OSS)/business support system (BSS) and an orchestrator. Resource sharing may occur among resources (e.g., a cluster of central processing units (CPUs) or virtual CPUs) within a domain. A domain may be a region that includes multiple data centers or multiple regions of a service provider or a cloud service provider. Resource sharing among domains, such as among service providers or among service providers and cloud service providers may also occur.

As further shown in FIG. 1D, and by reference number 110, the domain system 105 may receive a resource request for the domain. In some implementations, the domain system 105 may receive multiple requests from various user devices and may schedule these requests according to the classification described herein. For example, a user associated with the user device may cause the user device to generate a service request (e.g., a request for a connectivity service, a request for a cloud service, a request for an application, and/or the like) for the domain. In some implementations, the service request may require the domain to generate a resource request (e.g., during a time slot or a time interval). The domain may provide the resource request to the domain system, and the domain system may receive the resource request from the domain. In some implementations, the resource request may include a request for one or more of a compute resource of the domain, a memory resource of the domain, a storage resource of the domain, a network resource of the domain, a connectivity resource of the domain, an application resource of the domain, and/or the like. Although a single resource request is described herein, in some implementations, the domain system 105 may receive multiple (e.g., hundreds, thousands, tens of thousands, and/or the like) resource requests from the domain, and may manage servicing of the multiple resource requests for the domain. In some implementations, a resource request may be generated by resource consumers (e.g., network, application, and management).

As shown in FIG. 1E, and by reference number 115, the domain system 105 may assign a classification to the resource request and may identify a queue position for the resource request. For example, the domain system 105 may assign a classification to the resource request and may assign classifications to other resource requests. In some implementations, when assigning the classification to the resource request, the domain system 105 may assign, to the resource request, a first classification (e.g., a high classification) associated with connectivity and control resources of the domain when the resource request is associated with connectivity and control resources of the domain. Alternatively, the domain system 105 may assign, to the resource request, a second classification (e.g., a medium classification) associated with an application resource of the domain when the resource request is associated with an application of the domain. Alternatively, the domain system 105 may assign, to the resource request, a third classification (e.g., a low classification) associated with an orchestration application resource of the domain when the resource request is associated with an orchestration application of the domain. In some implementations, the first classification may take priority over the second classification and the third classification, and the second classification may take priority over the third classification. Alternatively, a classification (e.g., high importance, medium importance, or low importance) of the resource request may be provided in a header of the resource request.

Since the domain system 105 and the domain may receive large quantities of resource requests, the domain system 105 may utilize a queuing technique to assign queue positions for the large quantities of resource requests and to identify the queue position for the resource request. In some implementations, when identifying the queue position for the resource request (e.g., and other resource requests), the domain system 105 may utilize a round robin technique to identify the queue position for the resource request and queue positions for the other resource requests (e.g., where high priority requests are served first and low priority requests are served last), may utilize a weighted round robin technique to identify the queue position for the resource request and queue positions for the other resource requests (e.g., where each priority queuing may consume a limited quantity of available resources, such as compute, memory, and storage), and/or the like. In some implementations, the weighted round robin technique may serve a first resource request with a first priority before a second resource request with a second priority, when the first priority is higher than the second priority, and/or the like.

As shown in FIG. 1F, and by reference number 120, the domain system 105 may determine resource parameters for the resource request based on resource characteristics. For example, the resource request may include a request for particular resources of the domain, such as the network component, the storage component, the compute component, the memory component, and/or the like. Each of the different types of resources may include resource parameters, and the domain system 105 may determine the resource parameters based on the classification of the resource request and the queue position. In some implementations, the parameters for a resource (R) may include parameters associated with an available size or a component size of a resource(S), a network bandwidth (BW), a utilization of a resource (U), a maximum geographical distance to a source of the resource request (e.g., a maximum distance between the domain and the user device requesting service, MaxD), a minimum geographical distance to the source of the resource request (e.g., a minimum distance between the domain and the user device requesting service, MinD), an average geographical distance to the source of the resource request (e.g., an average distance between the domain and the user device requesting service, AvgD), a processor speed of a resource (P_{speed}), or a memory or storage read and write speed of a resource (Mem_{speed}), where a resource parameter=R<S, BW, U, MaxD, MinD, AvgD, P_{speed}, Mem_{speed}>.

As shown in FIG. 1G, and by reference number 125, the domain system 105 may utilize the resource parameters and optimized parameter values or optimized parameter threshold values or ranges, with a resource optimizer model, to generate optimized resource parameters. For example, the domain system 105 be associated with a resource optimizer model that generates optimized resource parameters. In some implementations, the resource optimizer model may generate the optimized resource parameters based on the resource parameters and optimized parameter values or optimized parameter threshold values or ranges. In some implementations, the optimized parameter values may include resource consumer-defined parameter values (e.g., a memory size of S Gigabytes, a utilization of U %, and/or the like). In some implementations, some of the resource parameters may be more important than others and may form the optimized resource parameters.

As shown in FIG. 1H, and by reference number 130, the domain system 105 may process resource types, with one or more resource scheduling models and based on the optimized resource parameters, to generate a consumption schedule for the resource types. For example, the domain system 105 may be associated with one or more resource scheduling models that generate the consumption schedule for the resource types based on the optimized resource parameters. In some implementations, the one or more resource scheduling models include a resource scheduling model that schedules resources of the domain based on an available size or a component size of a resource, a resource scheduling model that schedules resources of the domain based on a utilization of a resource, a resource scheduling model that schedules resources of the domain based on a maximum geographical distance to a source of the resource request, a resource scheduling model that schedules resources of the domain based on a minimum geographical distance to the source of the resource request, a resource scheduling model that schedules resources of the domain based on an average geographical distance to the source of the resource request, a resource scheduling model that schedules resources of the domain based on a processor speed of a resource, a resource scheduling model that schedules resources of the domain based on a memory or storage read and write speed of a resource, a resource scheduling model that schedules resources of the domain based on a network bandwidth, and/or the like.

In some implementations, the domain system 105 may utilize a first resource scheduling model that schedules a resource with a largest available size (R_{Smax}) first and a resource with a smallest available size last (R_{Smin}), so that the resource with the largest available size is consumed first and the resource with the smallest available size is consumed last. The first resource scheduling model may reschedule the resources when a size of any of the resources changes.

In some implementations, the domain system 105 may utilize a second resource scheduling model that schedules a resource with a least utilized component first (R_{Umin}) and a resource with a most utilized component last (R_{Umax}), so that the resource with the least utilized component is consumed first and the resource with the most utilized component is consumed last. The second resource scheduling model may reschedule the resources when a resource utilization of any of the resources changes.

In some implementations, the domain system 105 may utilize a third resource scheduling model that schedules a resource with a least maximum distance component first (R_{MaxDmin}) and a resource with a greatest maximum distance component last (R_{MaxDmax}), so that the resource with the least maximum distance component is consumed first and the resource with the greatest maximum distance component is consumed last. The third resource scheduling model may reschedule the resources when a maximum distance of any of the resources changes.

In some implementations, the domain system 105 may utilize a fourth resource scheduling model that schedules a resource with a least minimum distance component first (R_{MinDmin}) and a resource with a greatest minimum distance component last (R_{MinDmax}), so that the resource with the least minimum distance component is consumed first and the resource with the greatest minimum distance component is consumed last. The fourth resource scheduling model may reschedule the resources when a minimum distance of any of the resources changes.

In some implementations, the domain system 105 may utilize a fifth resource scheduling model that schedules a resource with a least average distance component first (R_{AvgDmin}) and a resource with greatest average distance component last (R_{AvgDmax}), so that the resource with the least average distance component is consumed first and the resource with the greatest average distance component is consumed last. The fourth resource scheduling model may reschedule the resources when an average distance of any of the resources changes.

In some implementations, the domain system 105 may utilize a sixth resource scheduling model that schedules a resource with a highest processor speed component first (R_{Pspeed-max}) and a resource with a lowest processor speed component last (R_{Pspeed-min}), so that the resource with the highest processor speed component is consumed first and the resource with lowest processor speed component is consumed last. The sixth resource scheduling model may reschedule the resources when a processor speed of any of the resources changes.

In some implementations, the domain system 105 may utilize a seventh resource scheduling model that schedules a resource with a highest memory speed component first (R_{Memspeed-max}) and a resource with a lowest memory speed component last (R_{Memspeed-min}), so that the resource with the highest memory speed component is consumed first and the resource with the lowest memory speed component is consumed last. The seventh resource scheduling model may reschedule the resources when a memory speed of any of the resources changes.

In some implementations, the domain system 105 may utilize an eighth resource scheduling model that schedules a resource with a highest bandwidth component first (RBW-max) and a resource with a lowest bandwidth component last (RBW-min), so that the resource with the highest bandwidth component is consumed first and the resource with the lowest bandwidth component is consumed last. The eighth resource scheduling model may reschedule the resources when a bandwidth of any of the resources changes.

In some implementations, the domain system 105 may utilize a ninth resource scheduling model that schedules a resource based on one or more combinations of the resource parameters (e.g., size, utilization, maximum distance, and/or the like). In some implementations, some of the resource parameters (e.g., size and utilization or size, utilization, and the maximum distance component), instead of all the resource parameters, may be considered more important than others, and a resource that is optimum based on the more important resource parameters may be selected scheduling. In some implementations, the domain system 105 may utilize an iterative process for selecting and scheduling a resource based on the resource parameters, as described below in connection with FIG. 1I. In some implementations, a resource may be selected and scheduled based on resource parameters defined by a user of the domain system 105 (e.g., a user of the user device).

As further shown in FIG. 1H, and by reference number 135, the domain system 105 may service the resource request based on the consumption schedule for the resource types. For example, the domain system 105 may utilize the consumption schedule for the resource types to service the resource request for the user device. The domain system 105 may service the resource request by causing the domain to provide, to the user device, the requested resources of the resource request. In some implementations, when servicing the resource request based on the consumption schedule for the resource types, the domain system 105 may cause the domain to provide the resource types to a source of the resource request (e.g., the user device) based on the consumption schedule.

As shown in FIG. 1I, in some implementations, when processing the resource parameters and the optimized parameter values, with the resource optimizer model, to generate the optimized resource parameters, the domain system 105 may iteratively adjust the optimized resource parameters by removing one or more of the resource parameters until the optimized parameter values are met. For example, the resource optimizer model may compare some or all of the resource parameters with the optimized parameter values (e.g., consumer thresholds) to determine whether the optimized parameter values are satisfied by the resource parameters (e.g., generate an optimum solution). If the optimized parameter values are not satisfied, the resource optimizer model may remove a least important resource parameter and may determine whether the optimized parameter values are satisfied by the remaining resource parameters. This process may continue until the optimized parameter values are satisfied. However, it is noted that in some instances there may be no optimal solution despite exhausting all alternatives, as further shown in FIG. 1I.

FIG. 1J depicts an example use case with two data centers (e.g., domains) and three customer locations (e.g., of user devices). As shown, a first data center may include a memory size(S) of 64 gigabytes (GB), a maximum data transfer rate of 1.6 GB/sec for memory, a memory utilization (U) of 75%, a maximum distance (MaxD) of 30 miles, and a minimum distance (MinD) of 15 miles. The second data center may include a memory size(S) of 128 GB, a maximum data transfer rate of 3.2 GB/sec for memory, a memory utilization (U) of 80%, a maximum distance of 60 miles, and a minimum distance of 40 miles. A usage scenario may include the connectivity service among the customer locations and the data centers using memory in one of the data centers. The consumer thresholds may include S>100 GB and U<75%. A decision based on the size and the utilization may not provide a solution due to the thresholds. The domain system 105 may drop one of the parameters (e.g., the size or the utilization). If the memory utilization is dropped, the second data center may be selected by the domain system 105. If the memory size is dropped, the first data center may be selected by the domain system 105. If a decision is made based on the maximum distance, the minimum distance, or the average distance, the first data center may be selected by the domain system.

FIG. 1K depicts an example use case with three data centers (e.g., domains), three customer locations (e.g., of user devices), and two applications (e.g., security and gaming). As shown, a first data center may include a memory size(S) of 64 GB, a maximum data transfer rate of 1.6 GB/sec for memory, a utilization (U) of 50%, a maximum distance of 30 miles, and a minimum distance of 15 miles. The second data center may include a memory size(S) of 128 GB, a maximum data transfer rate of 3.2 GB/sec for memory, a utilization (U) of 80%, a maximum distance of 60 miles, and a minimum distance of 40 miles. The third data center may include a memory size(S) of 32 GB, a maximum data transfer rate of 1.6 GB/sec, a utilization (U) of 75%, a maximum distance of 60 miles, and a minimum distance of 40 miles. A usage scenario may include the connectivity service among the customer locations and the data centers using memory in one of the data centers. The consumer thresholds may include S≥100 GB and U≤75%. Similarly, the security application may require use of additional memory in one of the data centers with the consumer thresholds set at S≥100 GB and U≤75%. A decision based on the size and the utilization may not provide a solution, due to the thresholds. The domain system 105 may drop one of the parameters (e.g., the size or the utilization). A decision based on the memory size may result in utilizing memory in the second data center. However, the connectivity and security application may be unable to access memory in the second data center simultaneously. In this situation, the domain system 105 may provide prioritization for the memory access in the second data center.

As shown in FIG. 1L, the domain system 105 is associated with one or more user devices (UDs) of customer device clusters (e.g., customer device cluster 1 through customer device cluster N), one or more network devices of a network provider (NP) network that includes network provider gateway clusters (e.g., network provider gateway cluster 1 through network provider gateway cluster M), and one or more network devices of cloud provider (CP) clusters (e.g., cloud provider 1 cluster 1 through cloud provider S cluster 1). Further details of the domain system 105, the network devices, the network provider network, and the customer device clusters are provided elsewhere herein.

As further shown in FIG. 1L, a first customer device cluster (e.g., customer device cluster 1) may include multiple user devices (e.g., D₁₁ through D₁ₙ), an Nth customer device cluster (e.g., customer device cluster N) may include multiple user devices (e.g., D_{N1} through D_{Nk}), and/or the like. A first network provider gateway cluster (e.g., network provider gateway cluster 1) may include multiple network devices (e.g., NP-GW₁₁ through NP-GW₁ₓ), an Mth network provider gateway cluster (e.g., network provider gateway cluster M) may include multiple network devices (e.g., NP-GW_{M1} through NP-GW_{My}), and/or the like. A first cloud provider cluster (e.g., cloud provider 1 cluster 1) may include multiple network devices (e.g., CP₁-GW₁ through CP₁-GWᵤ), another cloud provider cluster (e.g., cloud provider S cluster 1) may include multiple network devices (e.g., CP_{S}-GW₁ through CP_{S}-GWₜ), and/or the like.

In some implementations, the domain system 105 may determine a best CP-GW to access for a customer device by identifying a best NP-GW for a given customer device based on a least cost access path (e.g., minimum delay, jitter, loss, and/or the like) and resource utilizations below a threshold level. The domain system 105 may identify CP-GW locations supporting a customer requested application and may identify the best CP-GW for the best NP-GW identified above based on a least cost access path and resource utilizations below the threshold level. In some implementations, the domain system 105 may utilize the resource parameter optimization described herein to prioritize resources of the identified NP-GW and CP-GW.

In this way, the domain system 105 schedules and provides optimal resources of a domain to consumers of the domain. For example, the domain system 105 may determine resource parameters for scheduling resources based on a model that selects resources according to a set of parameters, such as size, utilization, distance, processor speed, memory/storage speed, bandwidth, and/or the like. The domain system 105 may select resources to meet specific consumer requirements and priorities for resource allocation. The domain system 105 may schedule the selected resources for use by assigning the selected resources in an order based on the optimization of the resource parameters, and may allocate the selected resources to fulfill consumer requests within the domain (e.g., a cloud provider region and associated network provider regions). The domain system 105 may dynamically adjust the allocation of the selected resources based on changes in the resource parameters, which may ensure efficient and responsive resource management for the domain. Thus, the domain system 105 may conserve computing resources, networking resources, and/or other resources that would have otherwise been consumed by handling poor consumer experiences associated with accessing domain resources, inefficiently utilizing domain resources, decreasing performance of domain resources, handling lost traffic associated with accessing domain resources, and/or the like.

As indicated above, FIGS. 1A-1L are provided as an example. Other examples may differ from what is described with regard to FIGS. 1A-1L. The number and arrangement of devices shown in FIGS. 1A-1L are provided as an example. In practice, there may be additional devices, fewer devices, different devices, or differently arranged devices than those shown in FIGS. 1A-1L. Furthermore, two or more devices shown in FIGS. 1A-1L may be implemented within a single device, or a single device shown in FIGS. 1A-1L may be implemented as multiple, distributed devices. Additionally, or alternatively, a set of devices (e.g., one or more devices) shown in FIGS. 1A-1L may perform one or more functions described as being performed by another set of devices shown in FIGS. 1A-1L.

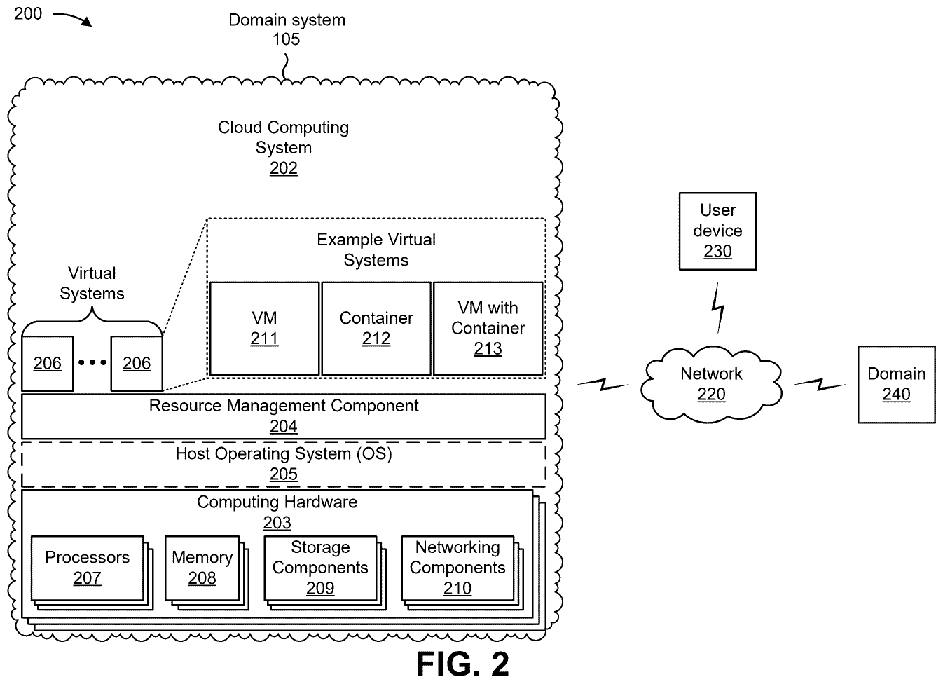

FIG. 2 is a diagram of an example environment 200 in which systems and/or methods described herein may be implemented. As shown in FIG. 2, the environment 200 may include the domain system 105, which may include one or more elements of and/or may execute within a cloud computing system 202. The cloud computing system 202 may include one or more elements 203-213, as described in more detail below. As further shown in FIG. 2, the environment 200 may include a network 220, a user device 230, and/or a domain 240. Devices and/or elements of the environment 200 may interconnect via wired connections and/or wireless connections.

The cloud computing system 202 includes computing hardware 203, a resource management component 204, a host operating system (OS) 205, and/or one or more virtual systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual systems 206. Using virtualization, the resource management component 204 enables a single computing device (e.g., a computer or a server) to operate like multiple computing devices, such as by creating multiple isolated virtual systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual systems 206. For example, the resource management component 204 may include or be a hypervisor (e.g., a bare-metal or Type 1 hypervisor, a hosted or Type 2 hypervisor, or another type of hypervisor) or a virtual machine monitor, such as when the virtual systems 206 are virtual machines 211. Additionally, or alternatively, the resource management component 204 may include a container manager, such as when the virtual systems 206 are containers 212. In some implementations, the resource management component 204 executes within and/or in coordination with a host operating system 205.

A virtual system 206 includes a virtual environment that enables cloud-based execution of operations and/or processes described herein using the computing hardware 203. As shown, the virtual system 206 may include a virtual machine 211, a container 212, or a hybrid environment 213 that includes a virtual machine and a container, among other examples. The virtual system 206 may support one or more applications using a file system that includes binary files, software libraries, and/or other resources required to execute applications on a guest operating system (e.g., within the virtual system 206) or the host operating system 205.

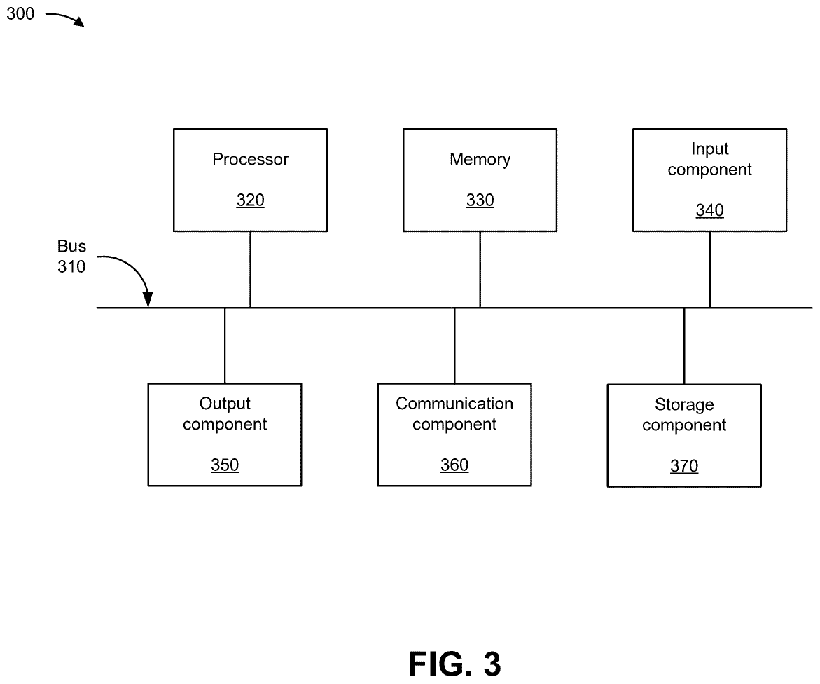

Although the domain system 105 may include one or more elements 203-213 of the cloud computing system 202, may execute within the cloud computing system 202, and/or may be hosted within the cloud computing system 202, in some implementations, the domain system 105 may not be cloud-based (e.g., may be implemented outside of a cloud provider domain) or may be partially cloud-based. For example, the domain system 105 may include one or more devices that are not part of the cloud computing system 202, such as a device 300 of FIG. 3, which may include a standalone server or another type of computing device. The domain system 105 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The user device 230 includes one or more devices capable of receiving, generating, storing, processing, and/or providing information, as described elsewhere herein. The user device 230 may include a communication device and/or a computing device. For example, the user device 230 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The domain 240 may include one or more devices capable of receiving, generating, storing, processing, and/or providing information, as described elsewhere herein. For example, the domain 240 may include a data center, multiple data centers, a service provider network, multiple regions of a service provider network, a cloud computing environment (e.g., similar to the cloud computing system 202), and/or the like. A data center may include a physical facility that organizations use to house applications and data. A design of a data center may be based on a network of computing and storage resources that enable delivery of shared applications and data. A data center may include several components, such as network devices (e.g., routers, switches, firewalls, and/or the like), storage systems, servers, application-delivery controllers, and/or the like.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the domain system 105, the user device 230, and/or the domain 240. In some implementations, the domain system 105, the user device 230, and/or the domain 240 may include one or more devices 300 and/or one or more components of the device 300. As shown in FIG. 3, the device 300 may include a bus 310, a processor 320, a memory 330, an input component 340, an output component 350, a communication component 360, and a storage component 370.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The storage component 370 stores information and/or software related to the operation and use of device 300. For example, the storage component 370 can include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

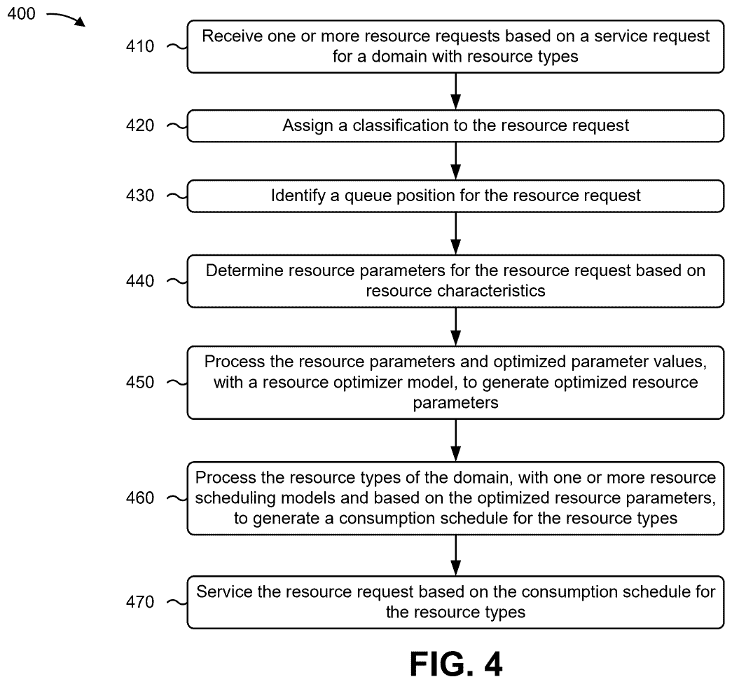

FIG. 4 depicts a flowchart of an example process 400 for scheduling and providing optimal resources of a domain to consumers of the domain. In some implementations, one or more process blocks of FIG. 4 may be performed by a device (e.g., the domain system 105). In some implementations, one or more process blocks of FIG. 4 may be performed by another device or a group of devices separate from or including the device. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving one or more resource requests based on a service request for a domain with resource types (block 410). For example, the domain system 105 may receive one or more resource requests based on a service request for a domain with resource types, as described above. In some implementations, the resource request includes a request for one or more of a compute resource of the domain, a memory resource of the domain, a storage resource of the domain, a network resource of the domain to support a connectivity service of the domain, or an application component of the domain as part of a cloud service.

As further shown in FIG. 4, process 400 may include assigning a classification to the resource request (block 420). For example, the domain system 105 may assign a classification to the resource request, as described above. In some implementations, assigning the classification to the resource request includes one of assigning, to the resource request, a first classification associated with connectivity and control components of the domain; assigning, to the resource request, a second classification associated with an application component of the domain; or assigning, to the resource request, a third classification associated with an orchestration component of the domain, wherein the first classification takes priority over the second classification and the third classification, and the second classification takes priority over the third classification.

As further shown in FIG. 4, process 400 may include identifying a queue position for the resource request (block 420). For example, the domain system 105 may identify a queue position for the resource request, as described above. In some implementations, identifying the queue position for the resource request includes one of utilizing a round robin technique to identify the queue position for the resource request, or utilizing a weighted round robin technique to identify the queue position for the resource request. In some implementations, the weighted round robin technique serves a first resource request with a first priority before a second resource request with a second priority, when the first priority is higher than the second priority.

As further shown in FIG. 4, process 400 may include determining resource parameters for the resource request based on resource characteristics (block 440). For example, the domain system 105 may determine resource parameters for the resource request based on resource characteristics, as described above. In some implementations, the resource parameters include parameters associated with one or more of an available size or a component size of a resource, a utilization of a resource, a maximum geographical distance to a source of the resource request, a minimum geographical distance to the source of the resource request, an average geographical distance to the source of the resource request, a processor speed of a resource, or a memory or storage read and write speed of a resource.

As further shown in FIG. 4, process 400 may include processing the resource parameters and optimized parameter values, with a resource optimizer model, to generate optimized resource parameters (block 450). For example, the domain system 105 may process the resource parameters and optimized parameter values, with a resource optimizer model, to generate optimized resource parameters, as described above. In some implementations, the optimized parameter values include resource consumer-defined parameter value boundaries. The resource consumer-defined parameter values are determined by domain system 105 based on service request. In some implementations, processing the resource parameters and the optimized parameter values, with the resource optimizer model, to generate the optimized resource parameters includes iteratively adjusting the optimized resource parameters by removing one or more of the resource parameters until the optimized parameter values are satisfied.

As further shown in FIG. 4, process 400 may include processing the resource types of the domain, with one or more resource scheduling models and based on the optimized resource parameters, to generate a consumption schedule for the resource types (block 460). For example, the domain system 105 may process the resource types of the domain, with one or more resource scheduling models and based on the optimized resource parameters, to generate a consumption schedule for the resource types, as described above. In some implementations, the one or more resource scheduling models includes one or more of a resource scheduling model that schedules resources of the domain based on an available size or a component size of a resource, a resource scheduling model that schedules resources of the domain based on a utilization of a resource, a resource scheduling model that schedules resources of the domain based on a maximum geographical distance to a source of the resource request, a resource scheduling model that schedules resources of the domain based on a minimum geographical distance to the source of the resource request, a resource scheduling model that schedules resources of the domain based on an average geographical distance to the source of the resource request, a resource scheduling model that schedules resources of the domain based on a processor speed of a resource, bandwidth for a resource interface, or a resource scheduling model that schedules resources of the domain based on a memory or storage read and write speed of a resource.

As further shown in FIG. 4, process 400 may include servicing the resource request based on the consumption schedule for the resource types (block 470). For example, the domain system 105 may service the resource request based on the consumption schedule for the resource types, as described above. In some implementations, the domain system 105 may cause the domain to provide the resource types to a source of the resource request based on the consumption schedule.

In some implementations, process 400 includes modifying the consumption schedule for the resource types based on a change to an available size or a component size of a resource of the domain. In some implementations, process 400 includes modifying the consumption schedule for the resource types based on a change to a utilization of a resource of the domain. In some implementations, process 400 includes modifying the consumption schedule for the resource types based on a change to a maximum geographical distance to a source of the resource request.

In some implementations, process 400 includes modifying the consumption schedule for the resource types based on a change to a minimum geographical distance to a source of the resource request. In some implementations, process 400 includes modifying the consumption schedule for the resource types based on a change to an average geographical distance to a source of the resource request. In some implementations, process 400 includes modifying the consumption schedule for the resource types based on a change to a processor speed of a resource of the domain. In some implementations, process 400 includes modifying the consumption schedule for the resource types based on a change to a memory or storage read and write speed of a resource. In some implementations, process 400 includes modifying the consumption schedule for the resource types based on a change to a bandwidth of a resource interface.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, a resource request for a domain with resource types;
assigning, by the device, a classification to the resource request;
identifying, by the device, a queue position for the resource request;
determining, by the device, resource parameters for the resource request based on resource characteristics;
processing, by the device, the resource parameters and optimized parameter values, with a resource optimizer model, to generate optimized resource parameters;
processing, by the device, the resource types of the domain, with one or more resource scheduling models and based on the optimized resource parameters, to generate a consumption schedule for the resource types; and
servicing, by the device, the resource request based on the consumption schedule for the resource types.

2. The method of claim 1, wherein identifying the queue position for the resource request comprises one of:
utilizing a round robin technique to identify the queue position for the resource request; or
utilizing a weighted round robin technique to identify the queue position for the resource request.

3. The method of claim 2, wherein the weighted round robin technique serves a first resource request with a first priority before a second resource request with a second priority when the first priority is higher than the second priority.

4. The method of claim 1, wherein assigning the classification to the resource request comprises one of:
assigning, to the resource request, a first classification associated with connectivity and control resources of the domain;
assigning, to the resource request, a second classification associated with an application resource of the domain; or
assigning, to the resource request, a third classification associated with an orchestration application resource of the domain,
wherein the first classification takes priority over the second classification and the third classification, and the second classification takes priority over the third classification.

5. The method of claim 1, wherein the resource parameters include parameters associated with one or more of:
an available size or a component size of a resource,
a utilization of a resource,
a maximum geographical distance to a source of the resource request,
a minimum geographical distance to the source of the resource request,
an average geographical distance to the source of the resource request,
a processor speed of a resource,
bandwidth of a resource interface, or
a memory or storage read and write speed of a resource.

6. The method of claim 1, wherein the optimized parameter values include consumer-defined parameter value boundaries.

7. The method of claim 1, wherein the resource request includes a request for one or more of:
a compute resource of the domain,
a memory resource of the domain,
a storage resource of the domain,
a network resource of the domain,
a connectivity resource of the domain, or
an application resource of the domain.

8. A device, comprising:
one or more processors configured to:
receive a resource request for a domain with resource types,
wherein the domain includes one of a data center, a cloud computing environment, or multiple distributed data centers;
assign a classification to the resource request;
identify a queue position for the resource request;
determine resource parameters for the resource request based on resource characteristics;
process the resource parameters and optimized parameter values, with a resource optimizer model, to generate optimized resource parameters;
process the resource types of the domain, with one or more resource scheduling models and based on the optimized resource parameters, to generate a consumption schedule for the resource types; and
service the resource request based on the consumption schedule for the resource types.

9. The device of claim 8, wherein the optimized parameter values include consumer-defined parameter value boundaries.

10. The device of claim 8, wherein the one or more processors, to process the resource parameters and the optimized parameter values, with the resource optimizer model, to generate the optimized resource parameters, are configured to:
iteratively adjust the optimized resource parameters by removing one or more of the resource parameters until the optimized parameter values are satisfied.

11. The device of claim 8, wherein the one or more resource scheduling models includes one or more of:
a resource scheduling model that schedules resources of the domain based on an available size or a component size of a resource,
a resource scheduling model that schedules resources of the domain based on a utilization of a resource,
a resource scheduling model that schedules resources of the domain based on a maximum geographical distance to a source of the resource request,
a resource scheduling model that schedules resources of the domain based on a minimum geographical distance to the source of the resource request,
a resource scheduling model that schedules resources of the domain based on an average geographical distance to the source of the resource request,
a resource scheduling model that schedules resources of the domain based on a processor speed of a resource,
a resource scheduling model that schedules resources of the domain based on a resource interface bandwidth, or
a resource scheduling model that schedules resources of the domain based on a memory or storage read and write speed of a resource.

12. The device of claim 8, wherein the one or more processors are further configured to:
modify the consumption schedule for the resource types based on a change to an available size or a component size of a resource of the domain.

13. The device of claim 8, wherein the one or more processors are further configured to:
modify the consumption schedule for the resource types based on a change to a utilization of a resource of the domain.

14. The device of claim 8, wherein the one or more processors are further configured to:
modify the consumption schedule for the resource types based on a change to a maximum geographical distance to a source of the resource request.

15. A non-transitory computer-readable medium storing a set of instructions, the set of instructions comprising:
one or more instructions that, when executed by one or more processors of a device, cause the device to:
receive a resource request for a domain with resource types,
wherein the resource request includes a request for one or more of a compute resource of the domain, a memory resource of the domain, a storage resource of the domain, a network resource of the domain, a connectivity resource of the domain, or an application resource of the domain;
assign a classification to the resource request;
identify a queue position for the resource request;
determine resource parameters for the resource request based on resource characteristics;
process the resource parameters and optimized parameter values, with a resource optimizer model, to generate optimized resource parameters;
process the resource types of the domain, with one or more resource scheduling models and based on the optimized resource parameters, to generate a consumption schedule for the resource types; and
service the resource request based on the consumption schedule for the resource types.

16. The non-transitory computer-readable medium of claim 15, wherein the one or more instructions further cause the device to:
modify the consumption schedule for the resource types based on a change to a minimum geographical distance to a source of the resource request.

17. The non-transitory computer-readable medium of claim 15, wherein the one or more instructions further cause the device to:
modify the consumption schedule for the resource types based on a change to an average geographical distance to a source of the resource request.

18. The non-transitory computer-readable medium of claim 15, wherein the one or more instructions further cause the device to:
modify the consumption schedule for the resource types based on a change to a processor speed of a resource of the domain.

19. The non-transitory computer-readable medium of claim 15, wherein the one or more instructions further cause the device to:
modify the consumption schedule for the resource types based on one of a change to a bandwidth of a resource of the domain or a change to a memory or storage read and write speed of a resource.

20. The non-transitory computer-readable medium of claim 15, wherein the one or more instructions, that cause the device to service the resource request based on the consumption schedule for the resource types, cause the device to:
cause the domain to provide the resource types to a source of the resource request based on the consumption schedule.
